(19) United States
(12) Patent Application Publication
(10) Pub. No.: US 2004/0118038 A1
(43) Pub. Date: Jun. 24, 2004

(54) Knock-down structure

(76) Inventors: Ram Hilel, Haifa (IL); Rimon Ben Dor, Doar Carmiel (IL)

Correspondence Address: BIRCH STEWART KOLASCH & BIRCH, PO BOX 747, FALLS CHURCH, VA, 22040-0747, US

(21) Appl. No.: 10/281,361

(22) Filed: Oct. 28, 2002

(51) Int. Cl. A01G 9/00

(52) U.S. Cl. 47/17

(57) ABSTRACT

A knock-down greenhouse that without difficulty can be assembled or disassembled. The greenhouse structure includes a rectangular enclosure having an angled roof, all of whose walls are defined by interlocked modules. Each module consists of a transparent pane mounted on a frame whose branches are profiled to facilitate interlocking. Adjacent modules are interlocked at the junctions of their contiguous branches by a coupling rail that engages these branches.

### FIELD AND BACKGROUND OF THE INVENTION

This invention relates generally to the structure of constructions such as, for example, greenhouses, sheds and the like, and in particular to a knock-down structures assembled from interlocked modules, each having a transparent pane mounted in a frame whose branches are profiled to facilitate interlocking of modules by coupling rails.

### STATUS OF PRIOR ART

For sake of convenience, reference is made hereinafter to greenhouses, though it is appreciated that the invention is concerned with structures useful for a variety of purposes.

A conventional greenhouse structure provided with glass walls and a glass roof which is internally illuminated by sun rays to which the greenhouse is exposed under regulated temperature and humidity conditions to promote the growth of plants. A greenhouse can range in size from that of a room capable of accommodating a relatively small number of plants, to an immense heated glass hot house called a conservatory.

The concern of the present invention is with greenhouses of modest size suitable for an amateur horticulturist or hobbyist who lives in a private residence situated on a lawn or field having space available for a greenhouse to cultivate plants. A preferred site for a greenhouse is on the lawn behind the residence of the horticulturist. It is to be understood, however, that a knock-down greenhouse in accordance with the invention is not limited to non-commercial applications and is useable whenever the need exists for greenhouse facilities that can be quickly erected, and later dismantled.

The problem faced by the typical horticulturist is that a greenhouse which fully satisfies his requirement is one that he may not be able to afford. It takes skilled artisans to construct a standard greenhouse which before it can be erected requires that a foundation be laid down to support the frame of the structure. This frame which is usually formed of intersecting wood or metal beams creates open windows in which glass panes must be mounted, the panes being precut to match the geometry of the windows.

There are two factors which discourage a householder from erecting a standard greenhouse. The first factor is that the expenses entailed when erecting a standard greenhouse may be more than the householder is prepared or able to expend. The second factor is the permanent character of a standard greenhouse structure. A typical amateur horticulturist requires a greenhouse only in those seasons of the year during which plants cannot be grown outdoors. The horticulturist would therefore prefer a greenhouse that can be dismantled and stored during those seasons in which a greenhouse is not required, and which can be reassembled quickly when a need arises for a greenhouse.

### SUMMARY OF THE INVENTION

In view of the foregoing, the main object of this invention is to provide a knock-down, such as, a shed, a garage, a greenhouse structure useable by an amateur horticulturist for cultivating plants in a controlled environment, etc.

More particularly, an object of this invention is to provide a structure of the above type composed of modules interlocked by coupling rails, whereby the structure can be assembled or disassembled without the need to engage skilled artisans to do so.

Among the many advantages of a structure in accordance with the invention are the following:

A. The several modules and coupling rails by which the knock-down structure is erected can be stored and transported in shipping crates.

B. The overall cost of this knock-down structure is significantly low.

C. The knock-down structure though of dismantable design, possesses substantial strength and can withstand high winds and other harsh environmental conditions.

D. The modules which when interlocked create the walls of the structure are each constituted by a pane of transparent material, such as polycarbonate, ABS, Acryl or other transparent material of high strength mounted within an injection-molded frame which is integrated with the pane to provide shatter-proof walls.

E. The geometry of the structure can be tailored to satisfy the needs of its owner, and is not limited to box-like structures.

Briefly stated, these objects are attained in a knock-down structure that can, without difficulty, be assembled or disassembled. The structure includes a rectangular enclosure having an angled roof all of whose walls are defined by interlocked modules.

Each module consists of a transparent pane mounted on a molded plastic frame whose branches are profiled to facilitate interlocking. Adjacent modules are interlocked at the junctions of their contiguous branches by a coupling rail that engages these branches. The coupling rails applied to the junctions of adjacent modules to interlock these modules are designed to cause the modules to assume an angular relationship which depends on their location in the structure.

Thus in the vertical walls of the structure, the coupling rails maintain adjacent modules in coplanar relation which is at zero angle. But to form a roof wall angled with respect to a side wall, then the coupling rail must maintain an acute angle between the adjacent modules. To create the corners of the structure, the coupling rails act to maintain adjacent modules at right angles to each other.

### BRIEF DESCRIPTION OF THE DRAWINGS

For a better understanding of the invention as well as other objects and features thereof, reference is made to the annexed drawings wherein:

FIG. 1 is a perspective view of a preferred embodiment of a knock-down structure in accordance with the invention that can readily be assembled and disassembled;

FIG. 2 shows in perspective a portion of the structure in which adjacent modules are interlocked by coupling rails in various angular relationships;

FIG. 3 shows two adjacent modules interlocked by a rail in coplanar relationship, one of these modules being interlocked at an angle to a third module;

FIG. 4 is a sectional view of adjacent modules maintained at an acute angle by a coupling rail;

FIG. 4A shows in cross-section the configuration of the rail included in FIG. 4;

FIG. 5 is a sectional view of adjacent modules maintained by a coupling rail in coplanar relationship;

FIG. 5A is a cross-section of the rail shown in FIG. 5;

FIG. 6 is a section taken through adjacent modules interlocked by a coupling rail to hold the modules at right angles to each other;

FIG. 6A is a cross-section taken through the FIG. 6 rail;

FIG. 7 is a section taken through adjacent modules maintained by a coupling rail in coplanar relationship;

FIG. 7A is a cross-section taken through this coupling rail;

FIG. 8 shows spacers attached to contiguous branches of the frames adjacent modules, and coupling rails which engage the spacers to maintain the modules in coplanar relationship;

FIG. 9 is a perspective view of one of the modules;

FIG. 10 shows another form of module; and

FIG. 11 shows in perspective another embodiment of a greenhouse in which the modules are provided with polygonal panes.

### DETAILED DESCRIPTION OF THE INVENTION

First Embodiment:

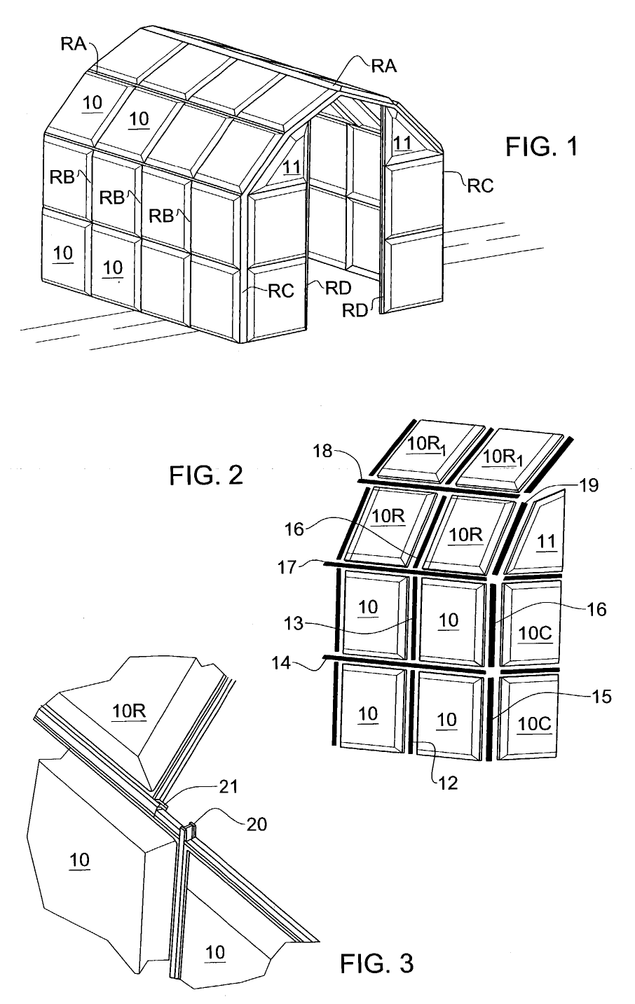

Referring now to FIG. 1 shown therein is a structure assembled according to an embodiment of the present invention, which according to an embodiment of the invention is a greenhouse, whose structure has a geometry defined by a rectangular enclosure having end walls at right angles to sides walls above which is a double-gabled roof. All of the walls of the roofed greenhouse are created by rectangular modules 10 and by trapezoidal modules 11, the modules each including a transparent plastic pane mounted within a frame.

Modules 10 and 11 are interlocked by coupling rails RA, RB, RC and RD, the rails creating a structural skeleton to support the modules. Rails RA which are horizontal, interlock modules forming the double-gabled roof of the structure. Vertical rails RB support modules forming side walls, whereas vertical rails RC support end wall modules. Vertical rails RD border the entry to the greenhouse. The rails may be made of aluminum, plastic, wood, etc.

A closer look is given by FIG. 2 which show modules 10 and 11 which are so interlocked as to create a side wall and a roof wall of the structure. This figure shows an array of four coplanar modules 10 which form a side wall of the greenhouse. The lower pair of adjacent modules 10 in the array are interlocked by a short vertical coupling rail 12, the upper pair being interlocked by a short vertical rail 3.

The lower pair of adjacent modules 10 in this array are interlocked to the upper pair by a horizontal coupling rail 14 whose length is greater than that of a short rail. At right angles to the array of modules which define a vertical side wall are corner modules 10C. These are interlocked to side wall modules 10 by short vertical coupling rails 15 and 16.

The double-gabled roof is formed by a lower pair of modules 10R and an upper pair of modules 10R₁, the lower gable being angled to the side wall of the structure by a coupling rail 17 and the upper gable being angled to the lower gable by a coupling rail 18. The trapezoidal corner module 11 is locked to an adjacent module 10 of the lower gable by a short rail 19.

FIG. 3 illustrates how the coupling rails function. Vertical rail 20 slides into the junction of adjacent vertical modules 10 which lie on a common horizontal axis, rail 20 engaging contiguous branches of the adjacent modules to decouple these modules one has only to slide out rail 20.

Horizontal rail 21 slides into the junction between roof module 10R and a side wall module 10. Rail 21 interlocks these adjacent modules to maintain them at an acute angle which depends on the slope of the roof.

Coupling Rails:

The walls of the greenhouse structure are formed by interlocked modules, adjacent modules being interlocked at their junctions by coupling rails designed to maintain the adjacent modules in an angular relationship that depends on where the modules are situated in the structure.

To this end, the four branches of the module frame are each profiled to present upper and lower jaws, and the coupling rails are designed to present complementary upper and lower claws adapted to engage the jaws of contiguous branches of adjacent modules to interlock these modules. It is the geometry of the upper claws of the rail relative to that of the lower claws that determines the angle maintained by these modules.

Thus a rail designed to bring about a zero angle acts to maintain adjacent modules in coplanar relationship, as is appropriate for a vertical side or end wall of the structure. For creating a corner of the structure, the rail must maintain adjacent module at a right angle to each other, whereas for a sloped roof the rail must maintain adjacent modules at an acute angle.

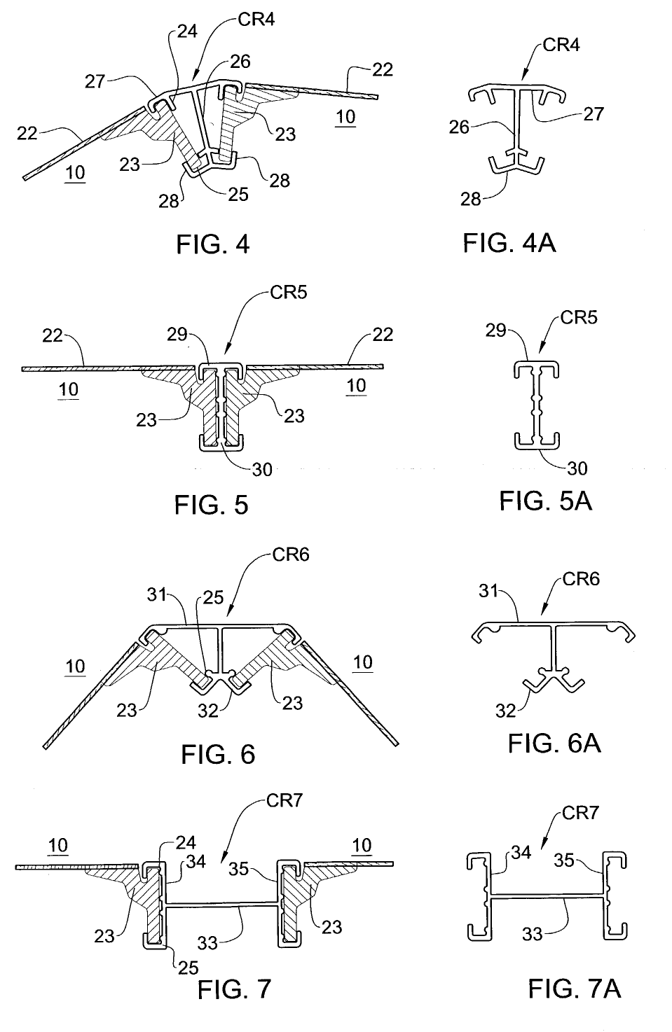

FIGS. 4 and 4A show adjacent modules 10 interlocked by a coupling rail CR4. Each module includes a transparent frame 22 mounted in a frame 23 whose four branches are profiled to form upper and lower jaws 24 and 25.

Pane 22 is preferably molded by polycarbonate thermoplastic resin. This transparent plastic has a high degree of light transmission (90°), it is dimensionally stable and has a high impact strength. Hence a polycarbonate greenhouse can withstand harsh environmental conditions. Also suitable for pane 22 is PLEXIGLAS, a transparent thermoplastic polymer (methyl methacrylate) or LUCITE, a transparent acrylic resin. Frame 23 is formed by injection-molding a thermoplastic material such as polyethylene about the pane to form an integrated structure. In practice, the frame may be reinforced by glass or carbon fibers.

Coupling rail CR4 is designed to maintain adjacent modules it interlocks at an acute angle which depends on the slope of the greenhouse roof. Rail CR4 includes a web 26 then runs its full length and is received in the junction between adjacent modules. Integral with one edge of web 26 is an upper pair of claws 27 supported by outstretched arms extending from opposite sides of the web. Integral with the other edge of the web is a lower pair of claws 28 supporting an arm extending from opposite sides of the web.

The upper and lower claws of coupling ring CR4 engage corresponding upper and lower jaws 25 and 24 of contiguous profiled frame branches of adjacent modules and therefore interlock these modules. In those instances where a particular module which has four sides has a module adjacent each side, then four coupling rails are required. The angular displacement of adjacent modules depends on the degree to which claws 27 of rail CR are separated relative to the degree to which the lower claws 28 are separated. It will be seen in FIG. 4A that the separation between the upper claws 27 is much greater than the separation between those of lower claws 28. As a consequence, the adjacent modules as maintained at an acute angle as shown in FIG. 4, the angle depending on the slope of the roof.

In rail CR5 shown in FIGS. 5 and 5A, the separation between the upper claws 29 is the same as that between the lower claws 30; hence the modules are slow at a zero angle and in coplanar relationship. In coupling rail CR6 shown in FIGS. 6 and 6A, the separation between the upper claws 31 is much greater than between those of the lower claws 32. As a consequence, the modules 10 are held at right angles to each other, as is required to form a corner.

In rail CR7 shown in FIG. 7 in which the web 33 is parallel to adjacent coplanar modules 10 and is provided by a pair of claws 34 along one edge of the web and a pair of claws 35 along the other edge which have identical separations, the rail CR7 then acts to space apart coplanar modules.

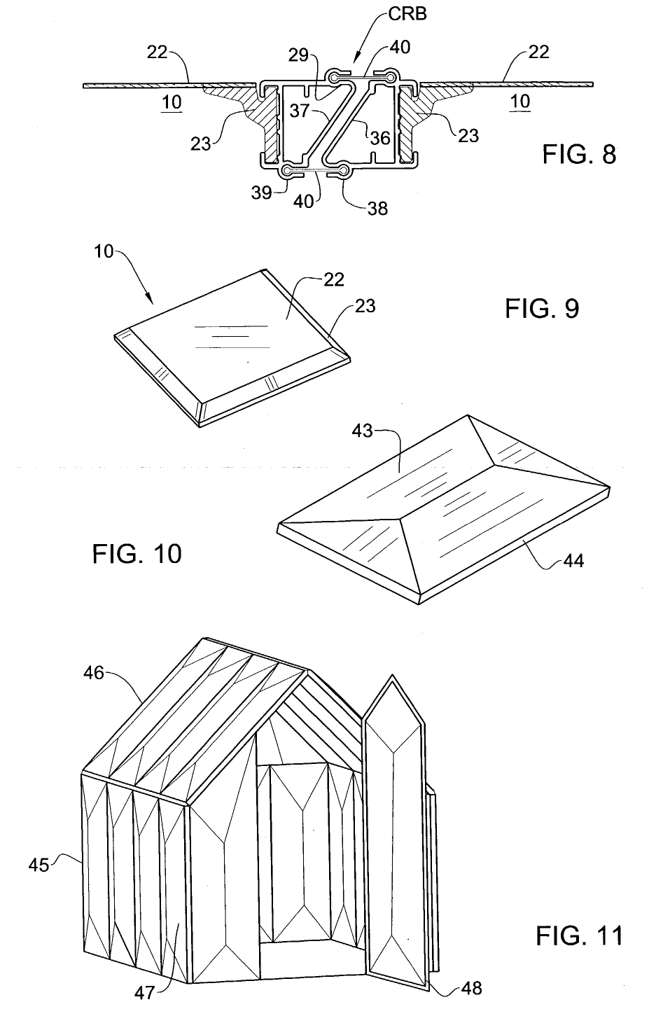

In FIG. 8 the rail CR8 for interlocking adjacent modules consists of complementary spacers 36 and 37 each having a pair of claws 38 or 29. These claws are adapted to engage corresponding jaws on contiguous frame branches 23 of adjacent modules. The spacers are interlinked by beaded slats 40 that bridge the claws in the spacers. This rail arrangement maintains adjacent modules in spaced apart coplanar relation.

Modules:

The modules required for a knock-down structure in accordance with the invention all require a transparent pane 22 mounted in a frame 23, as shown in FIG. 9. However, it is not necessary that the pane be in a flat conventional window pane form, for it may be configured to satisfy decorative or other requirements. The pane 22 shown in FIG. 9 is in the shape of a truncated four-sided pyramid.

FIG. 10 shows a rectangular module having a pane 43 in a multi-faceted polygon form, held within a rectangular frame 44. Pane 43 has a triangular cross-section so that the end facets are triangular, whereas the side facets are trapezoidal. It is the panes of the modules that form the facade of the greenhouse and a consumer therefore can be offered a choice of facades to suit his taste. Thus the panes could be in a corrugated form.

Second Embodiment:

In this embodiment as shown in FIG. 11, the structure includes a rectangular enclosure 45 having side walls joined to end walls above which is a single-gabled roof 46 formed by a pair of angled roof walls.

The walls are defined by interlocked modules such as module 47 having a polygon shaped pane similar to that shown in FIG. 10. Hinged to an end opening in the structure is a door 48 formed from a single module whose upper end is triangular so that it fits into the peak of the triangular roof 46.

While we have illustrated and described several embodiments of a greenhouse structure in accordance with the invention, it is to be understood that the invention may be applied to a variety of structure and many changes may be made therein without departing from the spirit of the invention.

1. A knock-down structure comprising:
I. An enclosure having side walls and end walls joined to the side walls;
II. A roof mountable above the enclosure having at least one roof wall;
III. A plurality of interlockable modules for defining the walls of the structure; each module including a transparent pane mounted in a frame; and
IV. Coupling rails, each rail being adapted to interlock adjacent modules by engaging contiguous frames thereof.

2. A structure as in claim 1, being a greenhouse in which the module pane is formed of a synthetic plastic having high light transmission characteristics.

3. A greenhouse as in claim 2, in which the plastic is a polycarbonate of high strength.

4. A structure as in claim 1, in which the frame is formed of thermoplastic material that is injection-molded about the pane to provide a unitary structure.

5. A structure as in claim 4, in which the frame is reinforced by fibers.

6. A structure as in claim 1, in which said roof is gabled and the roof modules are angled with respect to said side wall modules.

7. A structure as in claim 1, in which the roof is double-gabled.

8. A structure as in claim 1, in which adjacent modules which lie on a common horizontal axis are interlocked by a vertical coupling rail at the junction of these modules.

9. A structure as in claim 1, in which adjacent modules which lie on a common vertical axis are interlocked by a horizontal coupling rail at the junction a these modules.

10. A structure as in claim 1, in which the frame has a polygonal configuration.

11. A structure as in claim 10, in which the configuration of the pane is that of a four-sided truncated pyramid.

12. A structure as in claim 10, in which the pane has a triangular cross-section.

13. A structure as in claim 1, in which the frame has four branches, each profiled to form upper and lower jaws, and the coupling rail includes complementary upper and lower pairs of claws adapted to engage the jaws.

14. A structure as in claim 13, in which the upper pair of claws on the rail are spaced apart to a greater degree than the claws on the lower pair to cause the modules interlocked thereby to assume an angular relationship.

15. A structure as in claim 14, in which the angle is zero and the modules are then in coplanar relation.

16. A structure as in claim 14, in which the angle is an acute angle determined by the slope of the roof.

17. A structure as in claim 14, in which the angle is a right angle forming a corner of the enclosure.

18. A knock-down structure comprising:
I. An enclosure having side walls joined to end walls;
II. A roof mounted on the enclosure having at least one roof wall;
III. A plurality of modules each having a transparent pane mounted in a frame formed of branches profiled to define jaws, the modules being interlocked to form the walls of the greenhouse; and
IV. Coupling rails to interlock the modules each rail being provided with jaws to engage contiguous branches of adjacent modules.
